(19) United States
(12) Patent Application Publication
(10) Pub. No.: US 2019/0127257 A1
(43) Pub. Date: May 2, 2019

(54) METHOD OF THERMALLY TEMPERING GLASS LAMINATES USING SELECTIVE MICROWAVE HEATING AND ACTIVE COOLING

(71) Applicant: CORNING INCORPORATED, CORNING, NY (US)

(72) Inventors: Nikolaos Pantelis Kladias, Horseheads, NY (US); Gaozhu Peng, Horseheads, NY (US); Chunfeng Zhou, Painted Post, NY (US)

(21) Appl. No.: 16/094,014

(22) PCT Filed: Apr. 13, 2017
(86) PCT No.: PCT/US2017/027315

§ 371 Date: Oct. 16, 2018

Related U.S. Application Data
(60) Provisional application No. 62/323,941, filed on Apr. 18, 2016.

(51) Int. Cl. C03B 17/02; C03B 17/06; C03B 27/048; C03B 29/02; C03B 29/12; C03C 23/00

(52) U.S. Cl. CPC C03B 17/02; C03B 17/064; C03C 23/0065; C03B 29/025; C03B 29/12; C03B 27/048

(57) ABSTRACT

A system and method of thermally tempering a glass laminate including a core layer and cladding layers fused to opposing sides of the core layer, the method including: preheating the glass laminate to a temperature between the annealing point and the softening point of the core layer; and selectively heating the glass laminate using microwave radiation, while actively cooling the glass laminate, such that a temperature differential of at least about 30° C. is generated between the core and cladding layers.

This application claims the benefit of priority to U.S. Provisional Application No. 62/323941, filed Apr. 18, 2016, the content of which is incorporated herein by reference in its entirety.

### BACKGROUND

### Field

This disclosure relates systems and methods of thermally tempering glass laminates using selective microwave heating and active cooling.

### Technical Background

Thermal tempering, lamination, and ion exchange are three well-known methods to strengthen glass. Thermal tempering occurs when active heating is applied to glass followed by a fast cooling. Fast cooling can be used to create effective compressive stress, thereby strengthening the glass. However, as glass thickness is reduced, the compressive stress is also reduced, which may limit the effectiveness of thermal tempering.

Laminate fusion process for forming thin and flat glass has been developed where surface compressive stress is obtained when the coefficient of thermal expansion (CTE) of the core is larger than that of the clad of a laminated glass. The stress profile of the laminated glass is basically flat in the clad and core layers, and the stress depth of layer is determined by the clad thickness. A very large CTE mismatch between the core and clad layers may be beneficial to achieve high compressive stress on the clad layers. However, it may be difficult to develop core and clad pairs with a very large CTE mismatch in combination with other desirable characteristics. Thus, the ability to achieve very high surface compressive stress may be limited.

Accordingly, there is a need for an improved method of strengthening laminated glasses, and in particular thin laminated glasses.

### SUMMARY

Disclosed herein are systems and methods for strengthening laminated glass articles.

According to various embodiments, provided are methods of thermally tempering a glass laminate comprising a core layer and a cladding layer fused to the core layer, the method comprising: preheating the glass laminate to a temperature between an annealing point and a softening point of the core layer; applying microwave radiation to the glass laminate, such that the core layer absorbs more of the microwave radiation than the cladding layer; and cooling an outer surface of the glass laminate while applying the microwave radiation, to generate a temperature differential of at least about 30° C. between a center of the core layer and the outer surface of the glass laminate.

According to various embodiments, provided are methods of thermally tempering a glass laminate comprising a core layer and cladding layers fused to opposing sides of the core layer, the core layer having a microwave loss tangent that is at least 5 times greater than a microwave loss tangent of the cladding layers, within a temperature range between an annealing point and a softening point of the core layer, the method comprising: preheating the glass laminate to a temperature within the temperature range; and applying microwave radiation to the glass laminate, such that the core layer absorbs more of the microwave radiation than the cladding layers; and cooling a surface of the glass laminate during the application of the microwave radiation, to generate a heat transfer coefficient ranging from about 100 W/m²° C. to about 700 W/m²° C. at the surface of the glass laminate.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 illustrates an exemplary glass fusion process according to various embodiments of the present disclosure.

FIG. 2 is a sectional view of an exemplary glass laminate, according to various embodiments of the present disclosure.

FIG. 3 is a graph illustrating the microwave loss tangent (tan δ_{H}) of a microwave absorbing layer and the microwave loss tangent (tan δ_{L}) of a microwave transparent layer of an exemplary glass laminate, according to various embodiments of the present disclosure.

FIG. 4A is a schematic diagram illustrating an exemplary system for thermally tempering a glass laminate, according to various embodiments of the present disclosure.

FIG. 4B is a schematic diagram illustrating another exemplary system for thermally tempering a glass laminate, according to various embodiments of the present disclosure.

FIG. 5 is a block diagram illustrating an exemplary method of thermally tempering a glass laminate using microwave radiation and active cooling, according to various embodiments of the present disclosure.

FIG. 6 is a graph showing measured loss tangent data for a high-alkali glass and a low-alkali glass, according to various embodiments of the present disclosure.

FIG. 7 is a graph modeling resistive losses of applied microwave energy (5 KW at 30 GHz), according to distance from the core of an exemplary glass laminate, according to various embodiments of the present disclosure.

FIG. 8 is a graph modeling resistive losses of microwave energy (5 KW at 175 GHz) applied to an exemplary glass laminate, under preheating, microwave application, and forced convection cooling conditions, according to various embodiments of the present disclosure.

FIG. 9 is a graph modeling temperature variations between the center and the surface of an exemplary glass laminate, during the application of microwave energy (5 KW at 175 GHz) under preheating, microwave application, and forced convection initial conditions, according to various embodiments of the present disclosure.

FIG. 10 is a graph modeling center to surface temperature variations ΔT of an exemplary glass laminate for various microwave source settings and core dielectric properties, according to various embodiments of the present disclosure.

FIG. 11 is a graph modeling surface to core temperature variations ΔT of exemplary glass laminates, with and without microwave core layer heating, at different thermal transfer coefficients h, according to various embodiments of the present disclosure.

FIG. 12 is a graph modeling temperature vs. distance from the center of exemplary glass laminates heated with different amounts of microwave radiation for 0.5 seconds, after the exemplary glass laminates were uniformly preheated to 700° C., according to various embodiments of the present disclosure.

FIG. 13 is a graph modeling core to surface temperature variation ΔT over time, of exemplary glass laminates having 0.9 mm core layers and either 0.1 mm cladding layers or 0.05 mm cladding layers, according to various embodiments of the present disclosure.

FIG. 14 is a graph modeling center to surface temperature variations ΔT for exemplary glass laminates applied with various amounts of microwave energy, according to various embodiments of the present disclosure.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; that is, the phrase “A or B” means “A, B, or both A and B”. Exclusive “or” is designated herein by terms such as “either A or B”, for example. In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately described. The scope of the invention is not limited to the specific values recited when defining a range. Herein, the terms “clad” and “core” are relative terms.

According to various embodiments, provided are methods of thermally tempering glass laminates by selectively heating a core layer using microwave radiation, while actively cooling the glass laminate. The methods can create a significantly larger compressive stress on the surface of thin glasses and can enable effective thermal tempering of very thin glass laminates.

According to various embodiments, provided are microwave thermal tempering methods that allow the temperature across the thickness of the laminated glass to be more precisely controlled than in conventional methods. In particular, a relatively large temperature contrast may be achieved between the center and surface of the laminated glass, which yields increases in the compressive stress on the surface layers of the laminated glass.

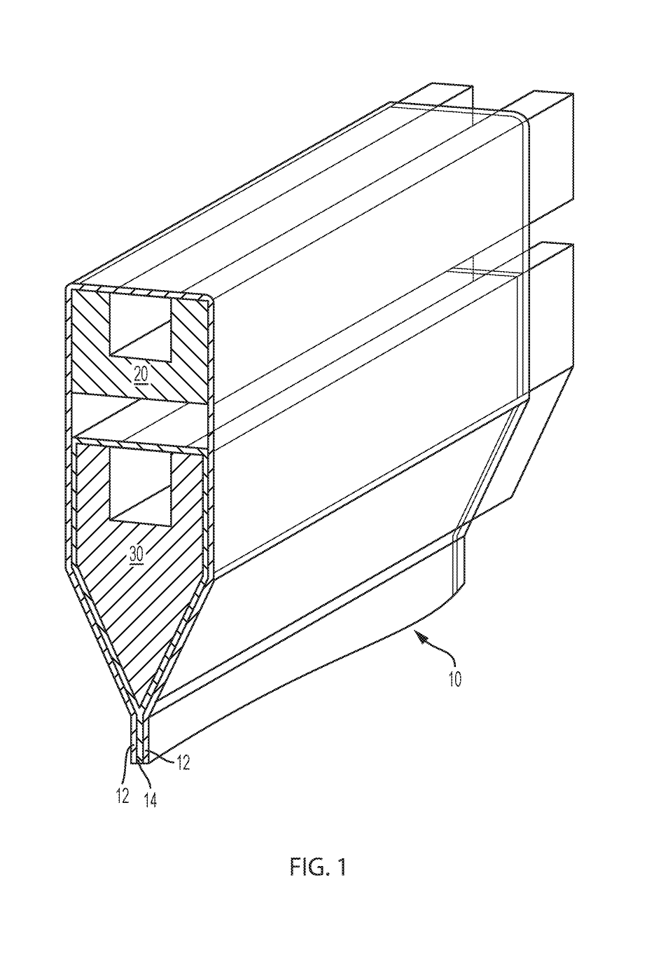

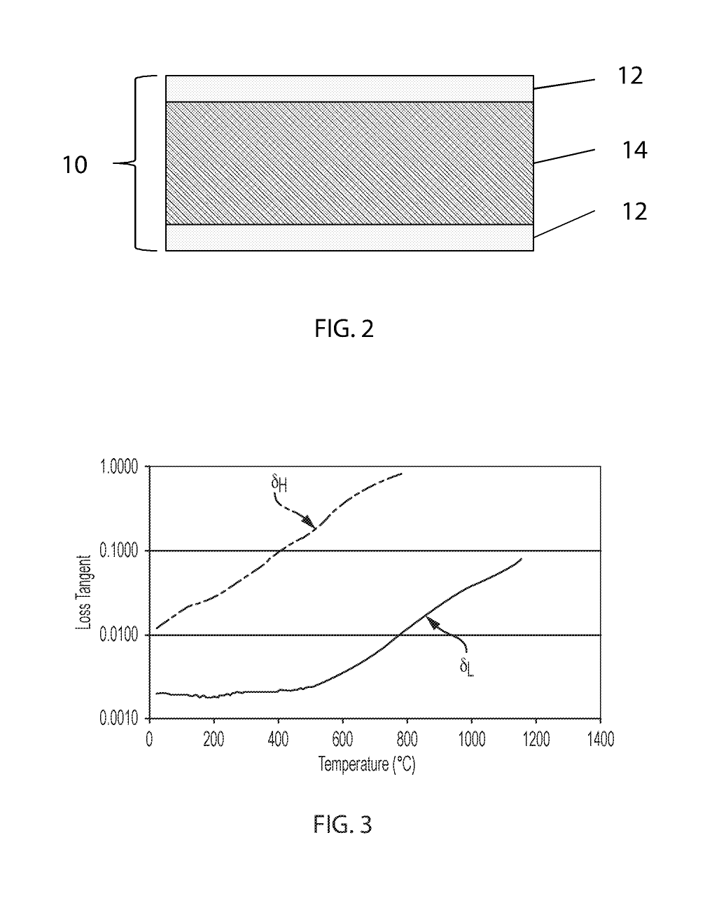

FIG. 1 is a cross-sectional view that illustrates an exemplary laminate fusion draw process, and FIG. 2 is a cross-sectional view of an exemplary glass laminate 10 that may be formed using the process of FIG. 1. The details of the process of FIG. 1 can be readily gleaned from available teachings in the art including, for example, U.S. Pat. Nos. 4,214,886, 7,207,193, 7,414,001, 7,430,880, 7,681,414, 7,685,840, 7,818,980, International Patent Application Pub. No. 2004094321, and U.S. Patent Pub. No. 2009/0217705. However, the present disclosure is not limited to any particular method of forming a glass laminate.

Referring to FIGS. 1 and 2, in an exemplary laminate fusion process, molten outer layer glass overflows from an upper isopipe 20 and merges with the core glass at the weir level of a bottom isopipe 30. The two sides merge and a three-layer flat glass laminate 10 comprising a core layer 14 and cladding layers 12 forms at the root of the core isopipe. The glass laminate 10 can pass through several thermal zones for sheet shape and stress management and is then cut at the bottom of the draw. The resulting flat glass laminate 10 can be further processed to have a 3D shape for applications such as handheld device and TV cover glass. It is noted that the cladding layers 12 might not be the outermost layers of the finished laminate, in some instances. In some embodiments, an interfaces between the core layer 14 and the cladding layers 12 are free of any bonding material such as, for example, an adhesive, a coating layer, or any non-glass material added or configured to adhere the respective cladding layers to the core layer. Thus, the cladding layers 12 are fused directly to the core layer 14 or are directly adjacent to the core layer. In some embodiments, the glass laminate comprises a diffusion layer disposed between the core layer and the cladding layer. For example, the diffusion layer can be a blended region comprising components of each layer adjacent to the diffusion layer (e.g., a blended region between two directly adjacent glass layers).

According to various embodiments of the present disclosure, a glass laminate 10 comprises a microwave absorbing layer, which may be the core layer 14 or one or more of the cladding layers 12, and a microwave transparent layer, which will be either the core layer 14 or one or more of the cladding layers 12 as determined by the choice of absorbing layer. For example, glass laminates prepared according to the present disclosure may comprise a microwave absorbing core layer sandwiched between microwave transparent outer layers. For purposes of illustration only and without limitation thereto, the core layer 14 is designated herein as the microwave absorbing layer, and the cladding layers 12 are designated herein as the microwave transparent layers. The glass laminate 10 may be formed by cutting a sheet of laminated glass into one or more pieces. In other words, the glass laminate may be in a non-molten state.

Reference herein to microwave “absorbing” layers or materials and microwave “transparent” layers or materials should not be taken to require 100% absorption or transmission of microwave energy. Rather, the terms are utilized herein in the relative sense such that the “absorbing” layer/material transmits less microwave radiation than the “transparent” layer/material, and vice versa. For example, to facilitate differential heating of a glass laminate, the microwave absorbing layer can have a microwave loss tangent (tan δ_{H}) that is at least 5 times larger than a loss tangent (tan δ_{L}) of the microwave transparent cladding layers, at least at one or more temperature points.

In practice, it may be beneficial to ensure that the loss tangent (tan δ_{H}) is at least a 5 times larger than the loss tangent (tan δ_{L}) over a wide range of temperatures. The loss tangent (tan δ) of a glass is defined as the factor of dielectric loss divided by dielectric constant and is a parameter of the glass that quantifies the dissipation of electromagnetic energy in the glass. Generally, glasses with relatively high microwave loss tangents (tan δ_{H}) will absorb relatively large amounts of microwave energy, while glasses with relatively low microwave loss tangents (tan δ_{H}) will absorb relatively small amounts of microwave energy. The difference between the respective loss tangents of two different materials in a glass laminate at a given temperature with a specified temperature range is referred to herein as the loss tangent differential of the glass laminate 10.

Microwave absorbing glass compositions useful according to embodiments of the disclosure may inherently be microwave absorbing, such as those with high alkali content, or may be rendered microwave absorbing through the incorporation of specific microwave absorbing components to the glass composition. Similarly, microwave transparent glass compositions useful according to embodiments of the disclosure may inherently be microwave transparent or may be rendered transparent through the addition of components selected to enhance microwave transparency. Concepts of the present disclosure are not limited to specific glass compositions.

According to various embodiments, one or both of the cladding layers 12 of the exemplary glass laminate 10 may be substantially transparent to microwave radiation, and the core layer 14 of the exemplary glass laminate 10 may be configured to absorb microwave radiation. By way of example, one or both the cladding layers 12 may have a relatively low alkali content, and the core layer 14 may have a relatively high alkali content. For example, one or both of the cladding layers 12 may be substantially free of (e.g., comprise less than about 0.1 mol %) or free of alkali metal.

FIG. 3 is a graph illustrating the microwave loss tangent (tan δ_{H}) of a microwave absorbing layer and the microwave loss tangent (tan δ_{L}) of a microwave transparent layer of an exemplary glass laminate, according to various embodiments of the present disclosure. Referring to FIG. 3, the loss tangent (tan δ_{H}) of the microwave absorbing layer is shown to be at least 5 times larger than the loss tangent (tan δ_{L}) of the microwave transparent layer, across the entire illustrated temperature range. In fact, the loss tangent (tan δ_{H}) is shown to be 10 times larger than the loss tangent (tan δ_{L}) over the majority of the temperature range illustrated in FIG. 3. Further, FIG. 3 shows that the difference between the loss tangents (tan δ_{H}) and (tan δ_{L}) is highest at temperatures ranging from about 600° C. to about 800° C.

Microwave heating is the result of absorption of microwave energy by a material exposed to the electromagnetic field distribution within a reflective cavity. It is based on the power absorption P per unit volume, which may be determined using the following Equation 1:

P=σ|E|²=2πƒε₀ε″_{eff}|E|²=2πƒε₀ε′ᵣ tan δ|E|² [1]

In Equation 1, |E| is the magnitude of the internal electric field, ε″_{eff} is the relative effective dielectric loss factor, ε₀ is the permittivity of free space, ƒ is the microwave frequency, σ is the total electric conductivity, ε′ᵣ is the relative dielectric constant, and tan δ is the loss tangent (energy loss required to store a given quantity of energy).

Important to the microwave processing of glass are the dielectric properties of glass as a function of temperature and frequency. As can be seen from Equation 1, the dielectric properties assume a significant role in the extent of power absorbed by a material. The majority of the absorbed microwave power is converted to heat within the material, as shown in the following Equation 2:

$$\frac{\partial T}{\partial t} = \frac{P}{{ρ C}_{p}} = \frac{2 {π f ɛ}_{0} {ɛ}_{r}^{′} tan δ {\vert E \vert}^{2}}{{ρ C}_{p}} \qquad [ 2 ]$$

In Equation 2, T is the temperature, t is the time, ρ is the density, Cₚ is the heat capacity, while the remaining variables are as defined in Equation 1. Equation 2 shows that heating rate is directly proportional to the loss tangent of a glass. This implies that heating rate of the microwave-absorbing layer of a laminate glass sheet will be much higher than that of the microwave-transparent layer of the same.

The dielectric properties also are important parameters in determining the depth to which the microwaves will penetrate into the material, which may be determined using the following Equation 3:

$$D == \frac{3 {λ}_{0}}{8.686 {πtanδ ( \frac{{ɛ}_{r}^{′}}{{ɛ}_{0}} )}^{1 / 2}} \qquad [ 3 ]$$

In Equation 3, D is the depth of penetration at which the incident power is reduced by one half, λ₀ is the microwave wavelength, while the remaining variables are as defined in Equations 1 and 2. As can be seen from Equation 3, the larger the values of tan δ and ε′ᵣ, the smaller the depth of penetration for a specific wavelength. The depth of penetration is important since it will determine the uniformity of heating throughout the material. High frequencies and large value of the dielectric properties will result in surface heating, while low frequencies and small values of dielectric properties will result in more volumetric heating.

For preparing a glass laminate according to the disclosure, heat may be generated very locally at a predetermined region of the microwave-absorbing layer using this selective microwave heating approach. The amount of energy thus applied may be carefully controlled and concentrated, since other regions would comprise glass that is relatively transparent to the microwave radiation. Further, a microwave-absorbing layer will be heated faster than a microwave-transparent layer. This way, the energy used may be reduced, cycle times shortened, and mechanical and other properties of the final laminate glass sheet can be adapted and optimized for various requirements and applications.

According to various embodiments, provided is a system and method for thermally tempering a glass laminate using microwave radiation and active cooling. In particular, microwave radiation may be selectively applied to a microwave absorbing core layer, while active cooling may be simultaneously, or substantially simultaneously, applied to cladding layers, such that a thermal gradient may be formed in a laminated glass sheet.

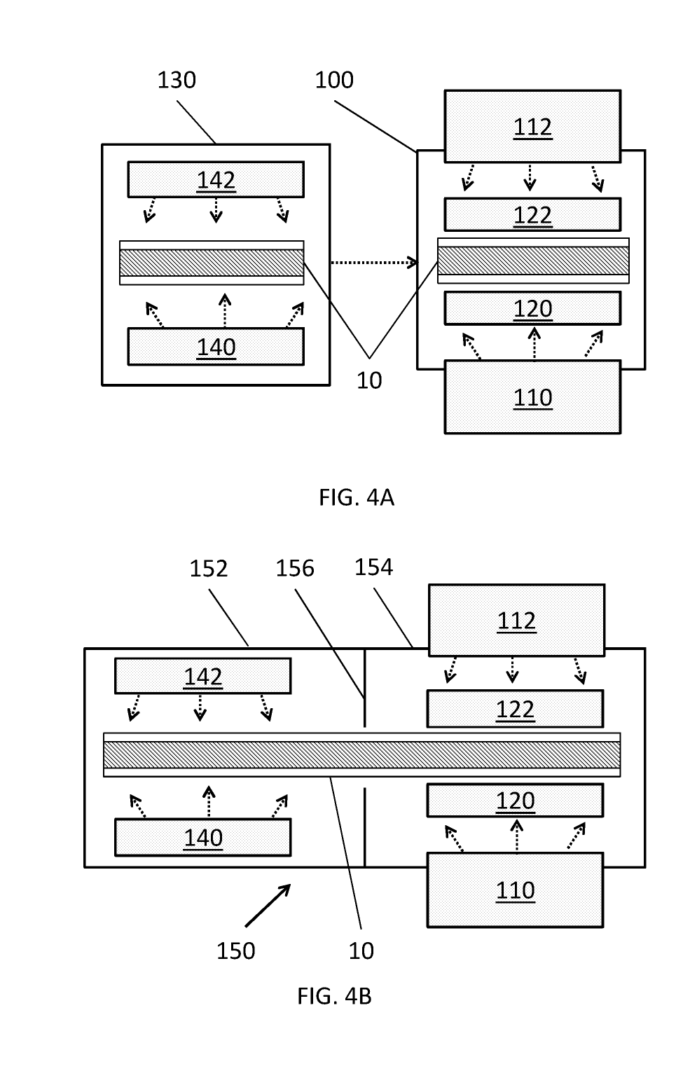

FIG. 4A is a schematic diagram illustrating an exemplary system for thermally tempering a glass laminate 10, according to various embodiments of the present disclosure. The glass laminate 10 may be tempered while in a non-molten state. Referring to FIG. 4A, the system may include a microwave housing 100, a first microwave source 110, a second microwave source 112, a first cooler 120, and a second cooler 122. In various embodiments, the system may be configured for batch tempering one or more separate glass laminates 10.

The housing 100 may be lined with or made of a microwave reflective material, such as a metal (e.g., copper) or the like. Accordingly, the housing 100 may be configured to prevent the escape of microwave radiation applied to the glass laminate 10.

The microwave sources 110, 112 may be disposed on opposing sides of the housing 100. For example, the microwave sources 110, 112 may be disposed on top and bottom surfaces of the housing 100. The microwave sources 110, 112 may be configured to direct microwave radiation toward a glass laminate 10 disposed in the housing 100, from opposing surfaces thereof. For example, the microwave sources 110, 112 may be microwave wave guides configured to guide microwave radiation toward the glass laminate 10, from one or more microwave generators disposed outside or on the housing 100. In the alternative, the microwave sources 110, 112, may include microwave generators and microwave waveguides.

The microwave sources 110, 112 may be configured to provide microwave radiation having any frequency in the microwave range (e.g., from 1 to 300 GHz). For example, microwave sources 110, 112 may be configured to provide microwave radiation having a frequency ranging from about 0.3 to about 300 GHz, from about 50 to about 300 GHz, from about 100 to about 300 GHz, or from about 175 to about 300 GHz. In some embodiments, the frequency may range from about 30 to about 175 GHz. According to some embodiments and as discussed below, higher microwave frequencies, such as from about 175 to about 300 GHz may be preferred, due to providing more even heating (e.g., reduced cavity resonance) of microwave absorbing layers. A power level of the microwave radiation may range from about 2 to about 15 kW, such as from about 2.5 to about 10 kW.

The coolers 120, 122 may be configured to support and/or actively cool opposing sides of the glass laminate 10. The coolers 120, 122 may be formed of a material that is substantially transparent to microwave radiation. In some embodiments, the coolers 120, 122 may be formed of alumina, fused quartz, polytetrafluoroethylene, or the like. For example, the coolers 120, 122 may be air bearings formed of a ceramic material. The coolers 120, 122 may be configured to channel cooled air (e.g., generate forced convection) onto opposing sides of the glass laminate 10, to convectively cool the glass laminate 10. However, the present disclosure is not limited to any particular type of cooling device.

The active cooling may result in a much higher cooling rate, as compared to natural convection. Forced convection operates to cool the surfaces of the glass laminate 10 faster than heat can be transferred from the core 14 to outer surfaces of the cladding layers 12, thereby creating a thermal gradient through the thickness of the glass laminate 10, which can be used to generate compressive stress in the glass laminate 10. For example, convective heat transfer coefficients of ranging from about 100 to about 700 W/m²° C. may be applied to the glass laminate 10. However, in other embodiments, convective heat transfer coefficients of up to 1000 W/m²° C. may be applied.

The system may optionally include a preheater 130. The preheater 130 may include first and second heat sources 140, 142 configured to preheat the glass laminate 10. In particular, the heat sources 140, 142 may be configured as infra-red, convection, or conduction heat sources, to evenly heat the glass laminate 10. However, the present disclosure is not limited to any particular type of heat source.

The microwave loss tangent of an alkali glass may increase as the temperature of the alkali glass increases. This may be due to the increased freedom of motion of alkali metals in glass at higher temperatures. Accordingly, the preheater 130 may be used to preheat the glass laminate 10 to a temperature at which microwave radiation is more efficiently absorbed (e.g., coupled to a microwave absorption layer), thereby improving the efficiency of the system. For example, the preheater 130 may be configured to preheat the glass laminate 10 to a temperature between the annealing point (e.g., the temperature at which the glass has a viscosity of 10^{13.18} poise) and the softening point (e.g., the temperature at which the glass has a viscosity of 10^{7.6} poise) of the core layer 14. After preheating, the glass laminate 10 may be conveyed to the microwave housing 100 for tempering.

FIG. 4B is a schematic diagram illustrating another exemplary system for thermally tempering a glass laminate 10, according to various embodiments of the present disclosure. The system FIG. 4B is similar to the system of FIG. 4A, and as such, only the differences therebetween will be discussed in detail.

Referring to FIG. 4B, the system includes a housing 150 that includes a first chamber 152 and a second chamber 154, which are separated by a partition 156. In various embodiments, the glass laminate 10 may be in the form of a glass ribbon, and the system may be configured for continuous tempering the glass ribbon as the glass ribbon 10 is fed through the system. The first chamber 152 may be configured to preheat the glass laminate 10, and the second chamber 154 may be configured to temper the glass laminate 10. The glass laminate 10 may be conveyed between the first and second chambers 152, 154, such that the time between preheating and thermal treatment can be reduced. The partition 156 may be configured to block microwave and/or infra-red radiation.

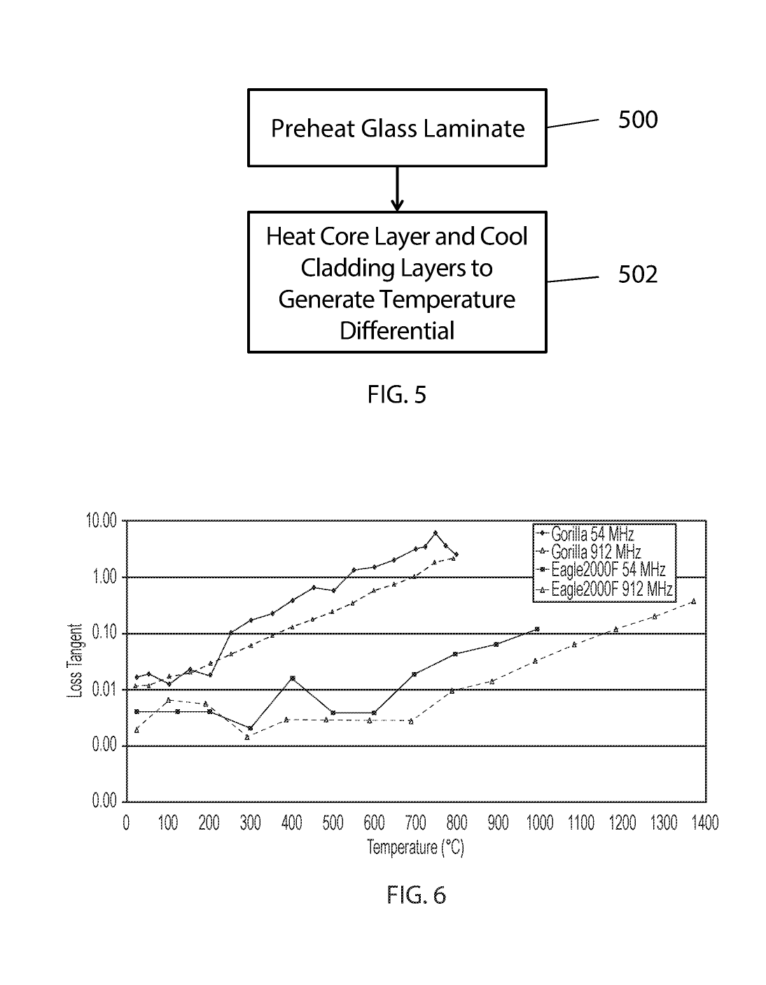

FIG. 5 is a block diagram illustrating a method of thermally tempering a glass laminate using microwave radiation and active cooling, according to various embodiments of the present disclosure. Referring to FIG. 5, in step 500, the glass laminate may be preheated. In particular, the glass laminate may be uniformly preheated to a temperature between the annealing point and the softening point of the core layer. In various embodiments, the glass laminate may be uniformly preheated to a temperature between the annealing point and the softening point of the cladding layers, if the annealing point of the cladding layers is higher than the annealing point of the core layers, for example.

For example, step 500 may include uniformly preheating the glass laminate to a temperature ranging from about 550° C. to about 900° C., such as from about 600 to about 750° C., or from about 600° C. to about 700° C. However, the preheating temperature may vary according to the compositions of the core and/or cladding layers. Herein, “uniformly preheating” refers to a heating process wherein all layers of the glass laminate are heated to substantially the same temperature, such as within about 5° C. or 10° C. of one another.

In some embodiments, the preheating may be performed using microwave radiation. However, in other embodiments, the preheating of step 500 may be performed using a non-microwave heat source, such as infra-red, convection, or conduction heat sources. In particular, such heat sources may more evenly and/or efficiently heat relatively cool glass laminates, such as room temperature glass laminates.

In step 502, microwave radiation may be applied to the preheated glass laminate, such that a temperature gradient is established between the core layer and the cladding layers. For example, microwave radiation may be applied to opposing sides of the glass laminate. Since the core layer has a higher microwave loss tangent than the cladding layers, the core layer may absorb more of the microwave radiation, and thus, a temperature gradient may be established between the core and cladding layers.

For example, in some embodiments, the microwave radiation may be configured to selectively heat the core to a higher temperature than the cladding layers, to establish a temperature gradient therebetween. In other exemplary embodiments, the microwave radiation may be configured to maintain the temperature of the core layer, while the cladding layers cool, to establish a temperature gradient therebetween. In other exemplary embodiments, the microwave radiation may be configured such that the core layer cools at a slower rate than the cladding layers, to establish a temperature gradient therebetween.

The microwave radiation may have a frequency ranging from about 1 to about 300 GHz, from about 50 to about 300 GHz, from about 100 to about 300 GHz, or from about 175 to about 300 GHz. In some embodiments, the frequency may range from about 30 to about 175 GHz. A power level of the microwave radiation may range from about 2 to about 15 kW, such as from about 2.5 to about 10 kW.

Step 502 may also include actively cooling the glass laminate. In particular, the active cooling and the microwave heating may be simultaneously performed. The active cooling may generate a heat transfer coefficient (“h”) at the surface of the glass laminate ranging from about 100 to about 700 W/m²° C., such as from about 200 to about 650 W/m²° C., or from about 400 to about 600 W/m²° C. In some embodiments, the active cooling may involve supplying cooled air to surfaces of the cladding layers, in order to convectively cool the cladding layers. In other embodiments, the active cooling may involve supplying a cooled inert gas (e.g., a noble gas such as He or the like) to surfaces of the cladding layers.

The microwave heating and active cooling may continue for a time period ranging from about 2 seconds to about 10 seconds, or longer. For example, the microwave heating may continue for a time period ranging from about 2.5 to about 8 seconds, from about 3 to about 7.5 seconds, or from about 3 to about 6 seconds. The active cooling and microwave heating may be applied until the glass laminate is cooled to below the strain point of the core layer and/or the strain point of the cladding layers. In other embodiments, the microwave heating and active cooling may continue until the glass substrate reaches an equilibrium temperature. In some embodiments, once a particular temperature differential has been established between the center of the core layer and the surface of the cladding layers, the microwave heating may be stopped and the active cooling may be continued. For example, the active cooling may continue until the glass laminate reaches room temperature. In other exemplary embodiments, the power and/or frequency of the microwave radiation may be gradually reduced to maintain a desired temperature gradient, during active cooling.

Accordingly, a temperature differential may be generated between the core and the cladding layers by the combination of microwave heating and active cooling. In various embodiments, according to the thickness of the core and/or cladding layers, the temperature differential may reach at least about 30° C., about 45° C., or about 50° C. For example, the microwave radiation and active cooling may be configured to generate a maximum temperature differential ranging from about 30° C. to about 80° C., from about 45° C. to about 75° C., such as from about 52° C. to about 66° C., or from about 52° C. to about 55° C. For example, a glass laminate having a thickness of about 0.7 mm may have a temperature differential ranging from about 35° C. to about 45° C. A glass laminate having a thickness of about 1.0 mm may have a temperature differential ranging from about 50° C. to about 67° C.

The magnitude of the temperature differential depends upon various factors such as, the microwave loss tangents of the core and cladding layers, the thicknesses of the core and cladding layers, the overall thickness of the glass laminate, a ratio of the thicknesses of the core and cladding layers, a power level of the microwave radiation, the frequency of the microwave radiation, and/or a heat transfer coefficient (“h”) generated at the surface of the glass laminate.

According to various embodiments, the microwave thermal tempering systems and methods of the present disclosure, such as the systems and method of FIGS. 4A, 4B, and 5, may be applied to a glass laminate having a core layer and a single cladding layer. In such embodiments, the systems and methods may result in asymmetric thermal tempering, which may provide higher compressive stress on the cladding side of the glass laminate, as compared to the opposing side of the glass laminate.

FIG. 6 is a graph showing measured loss tangent data (energy loss required to store a given quantity of energy, defined in Equation 2 above) for an alkali aluminosilicate glass available as Corning® Gorilla® glass from Corning Incorporated, Corning, N.Y., and an alkaline earth boro-aluminosilicate glass available as Corning® Eagle2000™ glass from Corning Incorporated, Corning, N.Y. The graph also shows the effect of microwave frequencies. The measurements were taken using the cavity perturbation method. As shown in FIG. 6, up to a two-order magnitude difference of loss tangent exists between the Gorilla glass and the Eagle²⁰⁰⁰ glass at all frequencies studied. The loss tangent difference increases with increasing temperature. Accordingly, FIG. 6 shows that for a glass laminate including a glass layer that is substantially alkali free or alkali free, and a glass layer that includes alkali metal, microwave radiation can be used for selectively heating of the alkali-containing layer with little energy absorption in the substantially alkali free or alkali free layer.

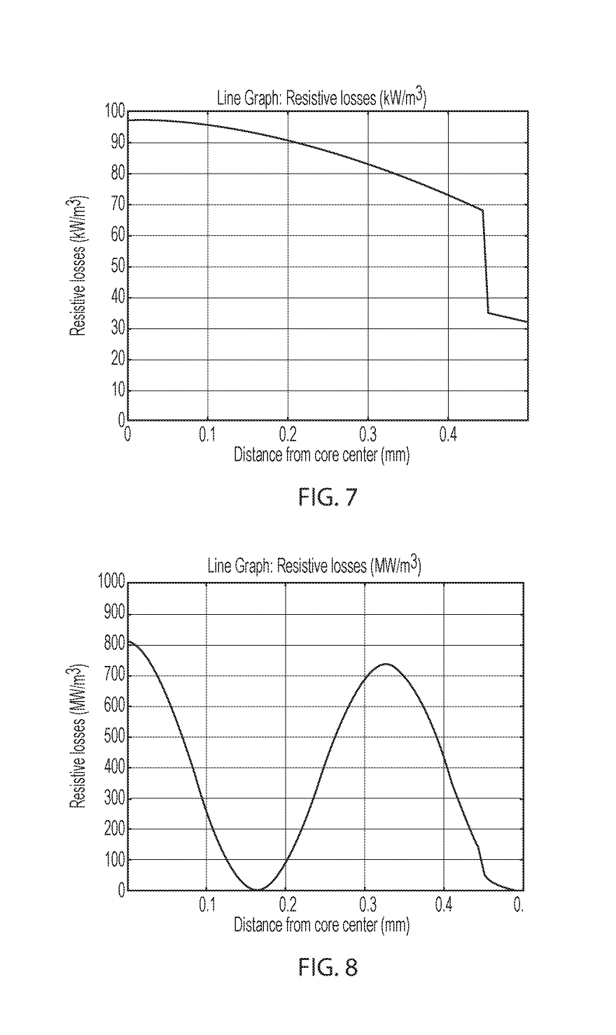

FIG. 7 is a graph modeling resistive losses of applied microwave energy (5 kW at 30 GHz), according to distance from the core of a 1 mm thick exemplary glass laminate, according to various embodiments of the present disclosure. The graph is based on an exemplary glass laminate uniformly preheated to 700° C. and that includes a 0.9 mm thick core layer of Gorilla® glass and two opposing 0.05 mm thick cladding layers of Eagle²⁰⁰⁰™ glass. The application of microwave radiation is based on the use of two microwave sources configured to apply microwave radiation to opposing sides of the exemplary glass laminate. During the microwave application, forced convection cooling is applied to the opposing surfaces of the exemplary glass laminate, at an effective heat transfer coefficient of 500 W/m²° C.

Referring to FIG. 7, a decrease in resistive loss at about 0.45 mm coincides with the interface between the core layer and the cladding layers. Accordingly, it can be seen that the core layer may be preferentially heated due to its higher loss tangent and corresponding higher microwave absorption rate, as compared to the cladding layers.

FIG. 8 is a graph modeling resistive losses of microwave energy (5 kW at 175 GHz) applied to the 1 mm thick exemplary glass laminate, under the above preheating, microwave application, and forced convection cooling conditions, according to various embodiments of the present disclosure. Referring to FIG. 8, the core layer is shown to be preferentially heated due to its higher loss tangent. The drop off at about 0.45 mm coincides with the interface between the core layer and the cladding layers. Further, the use of higher frequency microwave radiation (i.e., 175 GHz as compared to 30 GHz) resulted in significantly higher resistive losses (e.g., higher heat generation). The two peaks in the core layer show that the core layer acts as a resonant cavity for the microwave field.

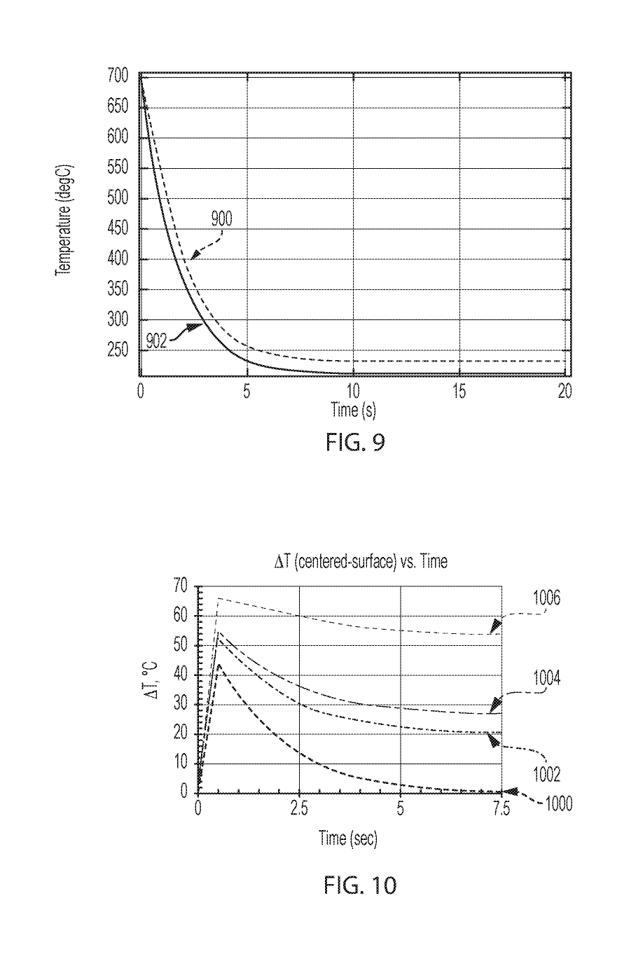

FIG. 9 is a graph modeling temperature variations between the center and the surface of an exemplary glass laminate having dimensions as described with regard to FIG. 7, during the application of microwave energy (5 kW at 175 GHz) under the above preheating, microwave application, and forced convection initial conditions, according to various embodiments of the present disclosure. Referring to FIG. 9, line 900 represents the temperature of the center of the glass laminate, and line 902 represents the temperature of the surface of the glass laminate. It can be seen that the surface cools faster than the center of the exemplary glass laminate, due to the core layer absorbing more microwave radiation than the cladding layers.

FIG. 10 is a graph modeling center to surface temperature variations ΔT of an exemplary glass laminate having dimensions as described with regard to FIG. 7, for various microwave source settings and core dielectric properties, according to various embodiments of the present disclosure. Referring to FIG. 10, line 1000 represents temperature variations without microwave heating, line 1002 represents temperature variations for 5 kW microwave heating at 175 GHz, line 1004 represents temperature variations for 5 kW microwave heating at 175 GHz and a 1.5× microwave loss tangent, and line 1006 represents temperature variations for 10 kW microwave heating at 175 GHz and a 1.5× microwave loss tangent. The 1.5× microwave loss tangent corresponds to a 50% increase in the lossy component of the glass permittivity. In some embodiments and in FIG. 10, the 1.5× loss tangent corresponds to tan δ=0.0195

As shown in line 1000, the exemplary glass laminate that was not exposed to microwave heating, the temperature contrast reaches a maximum of 43° C. in less than a second and decreases quickly to 0 in about 7.5 seconds. As shown in lines 1002-1006, with microwave heating, higher temperature variations ΔT may be reached and may also be sustained for longer periods of time.

For example, lines 1002 and 1004 show that when 5 kW microwave power is used, the peak temperature variation ΔT is about 52° C. This represents more than 20% increase in the temperature difference, as compared to the case where thermal tempering is performed by convective cooling alone without microwave heating (line 1000). As shown in line 1006, when the microwave power is increased to 10 KW, the loss tangent of the core is increased by 50%, and the peak temperature variation ΔT between center and surface is about 65° C. This higher temperature variation ΔT may provide an unexpected increase in thermal tempering stress.

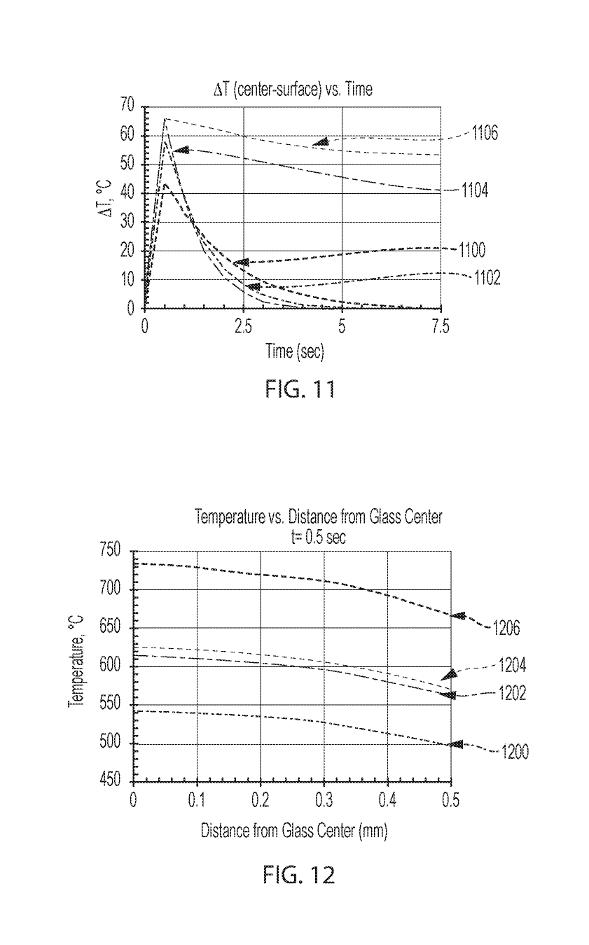

FIG. 11 is a graph modeling surface to core temperature variations ΔT of an exemplary glass laminate having dimensions as described with regard to FIG. 7, with and without microwave heating, at different surface thermal transfer coefficients h, according to various embodiments of the present disclosure. The graph is based on the exemplary glass laminates being evenly preheated to 700° C. Referring to FIG. 11, line 1100 represents temperature variations with no microwave heating and a surface thermal transfer coefficient h of 500 m²° C., line 1102 represents temperature variations with no microwave heating and a surface thermal transfer coefficient h of 800 m²° C., line 1104 represents temperature variations with no microwave heating and a surface thermal transfer coefficient h of 1000 m²° C., and line 1106 represents temperature variations using a 174 GHz, 10 kW microwave source and a surface thermal transfer coefficient h of 500 m²° C.

Line 1106 demonstrates that heating the glass laminate with a 10 kW, 175 GHz microwave source, while cooling the surface to generate a thermal transfer coefficient h of 500 W/m²° C., can achieve the same peak temperature difference as when a thermal transfer coefficient h of 1000 W/m²° C. is applied (line 1104) without microwave heating of the core layer. A thermal transfer coefficient h of 1000 W/m²° C. may be very difficult to achieve. Thus, the microwave heating described herein can enable an increased temperature differential without the need to achieve such a high surface cooling rate. It should also be noted that the equilibrium temperature difference when microwave heating is applied is large compared to the equilibrium temperature difference when microwave heating is not applied, which may provide additional benefits as the temperature difference between the core and the surface of the glass laminate can be maintained for a longer period of time (see FIGS. 10, 11).

FIG. 12 is a graph modeling temperature vs. distance from the center of an exemplary glass laminates having dimensions as described with regard to FIG. 7, heated with different amounts of microwave radiation for 0.5 seconds, after the exemplary glass laminates were uniformly preheated to 700° C., according to various embodiments of the present disclosure. Line 1200 represents no microwave heating, line 1202 represents microwave heating with a 175 GHz, 5 kW microwave source and a nominal loss tangent, line 1204 represents microwave heating with a 175 GHz, 5 kW microwave source and a 1.5× microwave loss tangent, and line 1206 represents microwave heating with a 175 GHz, 10 kW microwave source and a 1.5× microwave loss tangent.

As can be seen in FIG. 12, the exemplary glass laminates heated with microwave radiation exhibit much higher temperatures and temperature gradients, as compared to the exemplary glass laminate that was not heated with microwave radiation. Because higher temperature gradients enable increased tempering stress, FIG. 12 shows that the application of microwave radiation provides the benefit of increasing tempering stress.

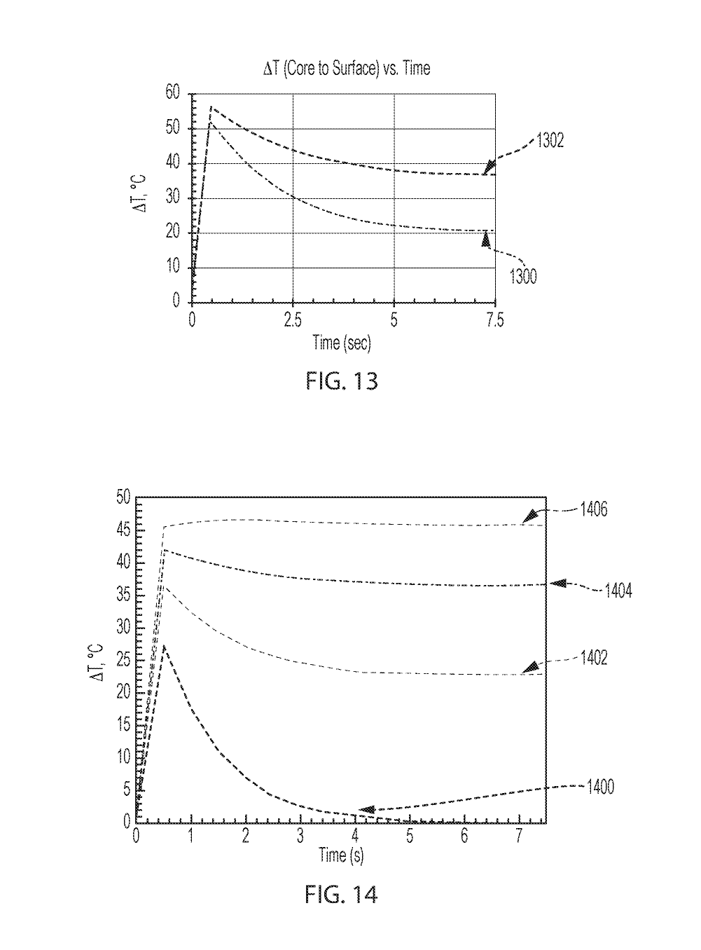

FIG. 13 is a graph modeling core to surface temperature variation ΔT over time, for exemplary glass laminates as described with regard to FIG. 7, except for having different cladding thicknesses, according to various embodiments of the present disclosure. The glass laminates were heated with a 175 GHz, 2.5 kW microwave source. Line 1300 represents temperature variations for a 0.05 mm thick cladding layers, and line 1302 represents temperature variations for 0.1 mm thick cladding layers. As shown in FIG. 13, increasing the thickness of the cladding layers increased the ΔT over time. Further, it is noted that line 1302 shows that a large ΔT may be achieved in the exemplary glass laminate having the 0.1 mm cladding layers, even at a relatively low microwave power of 2.5 kW.

To accurately estimate the stress profile in thermal tempering, stress relaxation when the glass is cooled down from a liquid state to a solid state should be considered. This process is very complicated and material properties with temperature are required. Results obtained from the models of FIGS. 10-12 show a larger temperature gradient in the glass when microwave heating is applied. It can be viewed as an increase of cooling rate as demonstrated in FIG. 11, in that the effective heat transfer coefficient can be doubled when microwave power is turned on. Herein, the effective heat transfer coefficient corresponds to a heat transfer coefficient that would be sufficient to achieve the same temperature differential between core and cladding layers, if no microwave heating was applied.

Higher cooling rates provide for higher surface compressive stress. It is expected that a roughly linear benefit in surface compressive stress can be obtained by increases in the center/surface temperature contrast. The compressive stress is expected to increase by roughly 50%, when the effective heat transfer coefficient is increased from 400 W/m²K to 1000 W/m²K (see FIG. 11).

It can be difficult to generate a thermal gradient in a thin glass article having a thickness of 0.7 mm or less. However, the present disclosure may be applied to thermally temper glass laminates having a thickness of 0.7 or less, such as thicknesses ranging from about 0.3 mm to about 0.7 mm. The present disclosure may also be applied to glass laminates having thicknesses of over 0.7 mm.

FIG. 14 is a graph modeling center to surface temperature variations ΔT for exemplary glass laminates, applied with various amounts of microwave energy, according to various embodiments of the present disclosure. The graph is based on exemplary glass laminates being preheated to 700° C., having a total thickness of 0.7 mm, a core layer thickness of 0.6 mm, and a cladding layer thickness of 0.05 mm. A convective heat transfer coefficient of 500 W/m²K is applied after preheating. Line 1400 represents temperature variations for no microwave heating, line 1402 represents temperature variations for a 175 GHz, 5 kW microwave source, line 1404 represents temperature variations for a 175 GHz, 8 kW microwave source, and line 1406 represents temperature variations for a 175 GHz, 10 kW microwave source.

As shown in FIG. 14, higher power levels of microwave radiation provided for significant ΔT increases. In particular, the peak ΔT difference increased from 27° C., when microwave heating is not applied (line 1400), to more than 45° C., when microwave heating of at 175 GHz with a 10 kW power level is applied (line 1406. In other words, microwave heating is shown to provide a 67% increase in peak ΔT.

Referring again to FIG. 2, according to various embodiments, in addition to the microwave absorption characteristics described above for the glass laminate 10, the core layer 14 may have a higher coefficient of thermal expansion (CTE) than the cladding layers 12. For example, the cladding layers 12 may be formed of Eagle²⁰⁰⁰ glass, and the core layer 14 may be formed of Gorilla glass. However, the present disclosure is not limited to any particular glass compositions.

The Gorilla glass may have a softening point ranging from about 900° C. to about 912° C., an annealing point ranging from about 628° C. to about 646° C., and a strain point ranging from about 574° C. to about 596° C., for example. The Eagle²⁰⁰⁰ glass may have a softening point of about 971° C., an annealing point of about 722° C., and a strain point of about 669° C.

In various embodiments, the cladding layers 12 may be fused to opposing sides of the core layer 14. The glass laminate 10 may be cut to form a glass article.

In some embodiments, glass laminate 10 may have a thickness of at least about 0.1 mm, at least about 0.5 mm, at least about 1.0 mm, at least about 2.0 mm, or at least about 3.0 mm. For example, the glass laminate 10 may have a thickness of from about 0.2 mm to about 5 mm, from about 1 mm to about 5 mm, or from about 1.5 mm to about 4 mm.

In some embodiments, a ratio of a thickness of core layer 14 to a thickness of glass laminate 10 is at least about 0.7, at least about 0.8, at least about 0.85, at least about 0.9, or at least about 0.95. In some embodiments, a thickness of the second layer (e.g., each of the cladding layers 12 is from about 0.01 mm to about 0.3 mm). In some embodiments, each of the cladding layers 12 is thinner than the core layer 14.

According to various embodiments, the cladding layers 12 may be substantially transparent to microwave radiation, and the core layer 14 may be configured to absorb microwave radiation. In particular, the cladding layers 12 may have a relatively low alkali content, and the core layer 14 may have a relatively high alkali content. For example, the cladding layers 12 may be substantially free of (e.g., comprise less than about 0.1 mol %) or free of alkali metal.

In some embodiments, a glass composition of the cladding layers 12 comprises a different average coefficient of thermal expansion (CTE) than a glass composition of the core layer 14. For example, the cladding layers 12 may be formed from a glass composition having a lower average CTE than the core layer 14. The CTE mismatch (i.e., the difference between the average CTE of the cladding layers 12 and the average CTE of the core layer 14) results in formation of compressive stress in the cladding layers 12 and tensile stress in the core layer 14 upon cooling of glass laminate 10 and prior to any thermal tempering as described herein. As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer” or ISO 7991:1987 “Glass—Determination of coefficient of mean linear thermal expansion.”

In some embodiments, the CTE of the core layer 14 and the CTE of the cladding layers 12 differ by at least about 1×10⁻⁷° C.⁻¹, at least about 2×10⁻⁷° C.⁻¹, at least about 3×10⁻⁷° C.⁻¹, at least about 4×10⁻⁷° C.⁻¹, at least about 5×10⁻⁷° C.⁻¹, at least about 10×10⁻⁷° C.⁻¹, at least about 15×10⁻⁷° C.⁻¹, at least about 20×10⁻⁷° C.⁻¹, at least about 25×10⁻⁷° C.⁻¹, at least about 30×10⁻⁷° C.⁻¹, at least about 35×10⁻⁷° C.⁻¹, at least about 40×10⁻⁷° C.⁻¹, or at least about 45×10⁻⁷° C.⁻¹. Additionally, or alternatively, the CTE of the core layer 14 and the CTE of the cladding layers 12 differ by at most about 100×10⁻⁷° C.⁻¹, at most about 75×10⁻⁷° C.⁻¹, at most about 50×10⁻⁷° C.⁻¹, at most about 40×10⁻⁷° C.⁻¹, at most about 30×10⁻⁷° C.⁻¹, at most about 20×10⁻⁷° C.⁻¹, at most about 10×10⁻⁷° C.⁻¹, at most about 9×10⁻⁷° C.⁻¹, at most about 8×10⁻⁷° C.⁻¹, at most about 7×10⁻⁷° C.⁻¹, at most about 6×10⁻⁷° C.⁻¹, or at most about 5×10⁻⁷° C.⁻¹. For example, in some embodiments, the CTE of the core layer 14 and the CTE of the cladding layers 12 differ by about 1×10⁷° C.⁻¹ to about 10×10⁻⁷° C.⁻¹ or about 1×10⁻⁷° C.⁻¹ to about 5×10⁻⁷° C.⁻¹. In some embodiments, the cladding layers 12 comprise a CTE of at most about 90×10⁻⁷° C.⁻¹, at most about 89×10⁻⁷° C.⁻¹, at most about 88×10⁻⁷° C.⁻¹, at most about 80×10⁻⁷° C.⁻¹, at most about 70×10⁻⁷° C.⁻¹, at most about 60×10⁻⁷° C.⁻¹, at most about 50×10⁻⁷° C.⁻¹, at most about 40×10⁻⁷° C.⁻¹, or at most about 35×10⁻⁷° C.⁻¹. Additionally, or alternatively, the cladding layers 12 comprise a CTE of at least about 10×10⁻⁷° C.⁻¹, at least about 15×10⁻⁷° C.⁻¹, at least about 25×10⁻⁷° C.⁻¹, at least about 30×10⁻⁷° C.⁻¹, at least about 40×10⁻⁷° C.⁻¹, at least about 50×10⁻⁷° C.⁻¹, at least about 60×10⁻⁷° C.⁻¹, at least about 70×10⁻⁷° C.⁻¹, at least about 80×10⁻⁷° C.⁻¹, or at least about 85×10⁻⁷° C.⁻¹. Additionally, or alternatively, the core layer 14 comprises a CTE of at least about 40×10⁻⁷° C.⁻¹, at least about 50×10⁻⁷° C.⁻¹, at least about 55×10⁻⁷° C.⁻¹, at least about 65×10⁻⁷° C.⁻¹, at least about 70×10⁻⁷° C.⁻¹, at least about 80×10⁻⁷° C.⁻¹, or at least about 90×10⁻⁷° C.⁻¹. Additionally, or alternatively, the core layer 14 comprises a CTE of at most about 120×10⁻⁷° C.⁻¹, at most about 110×10⁻⁷° C.⁻¹, at most about 100×10⁻⁷° C.⁻¹, at most about 90×10⁻⁷° C.⁻¹, at most about 75×10⁻⁷° C.⁻¹, or at most about 70×10⁻⁷° C.⁻¹.

In various embodiments, the relative thicknesses of the glass layers can be selected to achieve a glass article having desired strength properties. For example, in some embodiments, the glass compositions of the core layer 14 and the cladding layers 12 are selected to achieve a desired CTE mismatch, and the relative thicknesses of the glass layers are selected, in combination with the desired CTE mismatch, to achieve a desired compressive stress in the cladding layers and tensile stress in the core layer.

Without wishing to be bound by any theory, it is believed that the strength profile of the glass article can be determined predominantly by the relative thicknesses of the glass layers and the compressive stress in the cladding layers, and that the breakage pattern of the glass article can be determined predominantly by the relative thicknesses of the glass layers and the tensile stress in the core layer. Thus, the glass compositions and relative thicknesses of the glass layers can be selected to achieve a glass article having a desired strength profile and/or breakage pattern.

In some embodiments, the CTE mismatch between the core 14 and cladding layers 12, in combination with the microwave heating and active cooling, may operate to unexpectedly increase the compressive stress at the surface of a glass laminate 10. For example, the compressive stress of the cladding layers 12 may be at most about 800 MPa, at most about 500 MPa, at most about 350 MPa, or at most about 150 MPa. Additionally, or alternatively, the compressive stress of the cladding layers 12 is at least about 10 MPa, at least about 20 MPa, at least about 30 MPa, at least about 50 MPa, or at least about 250 MPa. Additionally, or alternatively, the tensile stress of the core layer 14 is at most about 150 MPa, or at most about 100 MPa. Additionally, or alternatively, the tensile stress of the core layer 14 is at least about 5 MPa, at least about 10 MPa, at least about 25 MPa, or at least about 50 MPa.

It will be apparent to those skilled in the art that various modifications and variations can be made without departing from the spirit or scope of the invention. Accordingly, the invention is not to be restricted except in light of the attached claims and their equivalents.

1. A method of thermally tempering a glass laminate comprising a core layer and a cladding layer fused to the core layer, the method comprising:
preheating the glass laminate to a temperature between an annealing point and a softening point of the core layer;
applying microwave radiation to the glass laminate, such that the core layer absorbs more of the microwave radiation than the cladding layer; and
cooling an outer surface of the glass laminate while applying the microwave radiation to generate a temperature differential of at least about 30° C. between a center of the core layer and the outer surface of the glass laminate;
wherein the cooling comprises directing a cooling fluid toward the outer surface of the glass laminate using substantially microwave transparent air bearings disposed on opposing sides of the glass laminate.

2. The method of claim 1, wherein the core layer has a microwave loss tangent that is greater than a microwave loss tangent of the cladding layer, at a given temperature.

3. The method of claim 1, wherein:
the glass laminate has a thickness of less than about 1.3 mm; and
the temperature differential is at least about 50° C.

4. The method of claim 1, wherein:
the glass laminate has a thickness of about 0.3 mm to about 0.7 mm; and
the temperature differential ranges from about 30° C. to about 45° C.

5. The method of claim 1, wherein the cooling generates a heat transfer coefficient of about 100 W/m²° C. to about 700 W/m²° C. at the outer surface of the glass laminate.

6. The method of claim 1, wherein the cooling generates a heat transfer coefficient of about 400 W/m²° C. to about 600 W/m²° C. at the outer surface of the glass laminate.

7. The method of claim 1, wherein the applying microwave radiation comprises applying microwave radiation to opposing sides of the glass laminate.

8. The method of claim 1, wherein the microwave radiation has a frequency of about 30 GHz to about 300 GHz and a power level of about 2.5 kW to about 10 kW.

9. The method of claim 1, wherein the microwave radiation has a frequency of about 30 GHz to about 175 GHz, and a power level of about 2.5 kW to about 10 kW.

10. The method of claim 1, wherein the preheating comprises heating the core layer and the cladding layer to substantially the same temperature using a non-microwave heat source.

11. The method of claim 1, wherein the applying microwave radiation comprises disposing the glass laminate in a housing comprising microwave sources configured to direct microwave radiation toward opposing sides of the glass laminate.

12. The method of claim 1, wherein:
the preheating comprises disposing the glass laminate in a first chamber of a housing, the first chamber comprising a non-microwave heat source configured to preheat the glass laminate; and
the applying microwave radiation comprises disposing the glass laminate in a second chamber of the housing, the second chamber comprising microwave sources configured to direct microwave radiation toward opposing sides of the glass laminate.

13. A method of thermally tempering a glass laminate comprising a core layer and cladding layers fused to opposing sides of the core layer, the core layer having a microwave loss tangent that is at least 5 times greater than a microwave loss tangent of the cladding layers within a temperature range between an annealing point and a softening point of the core layer, the method comprising:
preheating the glass laminate to a temperature within the temperature range;
applying microwave radiation to the glass laminate such that the core layer absorbs more of the microwave radiation than the cladding layers; and
cooling a surface of the glass laminate during the applying microwave radiation to generate a heat transfer coefficient of about 100 W/m²° C. to about 700 W/m²° C. at the surface of the glass laminate.

14. The method of claim 13, wherein the core layer has a microwave loss tangent that is greater than a microwave loss tangent of the cladding layers at all temperatures within the temperature range.

15. The method of claim 13, wherein the applying microwave radiation and the cooling are configured to generate a temperature differential of at least about 35° C. between a center of the core layer and the surface of the glass laminate.

16. The method of claim 15, wherein the temperature differential ranges from about 50° C. to about 66° C.

17. The method of claim 13, wherein the heat transfer coefficient ranges from about 400 W/m²° C. to about 600 W/m²° C.

18. The method of claim 13, wherein the microwave radiation has a frequency of about 30 GHz to about 300 GHz and a power level of about 2.5 kW to about 10 kW.

19. The method of claim 13, wherein the preheating comprises heating the core layer and the cladding layers to substantially the same temperature using a non-microwave heat source.

20. The method of claim 13, wherein:
the applying microwave radiation comprises applying microwave radiation to opposing sides of the glass laminate; and
the cooling comprises directing a cooling fluid toward the surface of the glass laminate using substantially microwave transparent air bearings disposed on the opposing sides of the glass laminate.
